(19) United States
(12) Patent Application Publication
(10) Pub. No.: US 2010/0066610 A1
(43) Pub. Date: Mar. 18, 2010

(54) MULTIBAND ANTENNA

(75) Inventor: Mao-Hsiu Hsu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/409,498

(22) Filed: Mar. 24, 2009

(30) Foreign Application Priority Data
Sep. 16, 2008 (CN) 200810304519.3

(51) Int. Cl. H01Q 1/38; H01Q 5/00

(52) U.S. Cl. 343/700 MS

(57) ABSTRACT

A multiband antenna located on a substrate includes a feed portion, a grounded portion, and an antenna body. The feed portion is connected to the substrate, delivering electromagnetic signals. The grounded portion is connected to the substrate. The antenna body is electrically connected to the feed portion and the grounded portion, transceiving electromagnetic signals. The antenna body includes a first radiator, a second radiator, a first resonator, and a second resonator. The first radiator is connected to the first radiator and the grounded portion. The second radiator is connected to the first radiator and the grounded portion. The first resonator is connected to the second radiator. The second resonator is connected to the second radiator. The second resonator and the first radiator are parallel and of different lengths.

### BACKGROUND

1. Technical Field

Embodiments of the present disclosure relate to antennas, and more particularly to a multiband antenna.

2. Description of Related Art

As communication technology is improved, weight, volume, cost, performance, and complexity of systems become more important, and antennas transceiving signals in such systems attract much focus in development. In a wireless local area network (WLAN), space receiving the antenna is limited despite data amounts transceived thereby increasing dramatically and the requirement to transceive all signals of WLAN bands, 802.11b (2.4 GHz) and 802.11a (5.2 GHz).

Currently, a challenge exists in being able to design compact antennas that operate in the frequency bands of 2.4 GHZ and 5.X GHz.

### BRIEF DESCRIPTION OF THE DRAWINGS

FIG. 1 is a schematic diagram of a multiband antenna in accordance with the disclosure;

FIG. 2 is a top view of the multiband antenna of FIG. 1;

FIG. 3 shows dimensions of the multiband antenna of FIG. 1; and

FIG. 4 is a graph showing return loss of the multiband antenna of FIG. 1.

### DETAILED DESCRIPTION OF CERTAIN INVENTIVE EMBODIMENTS

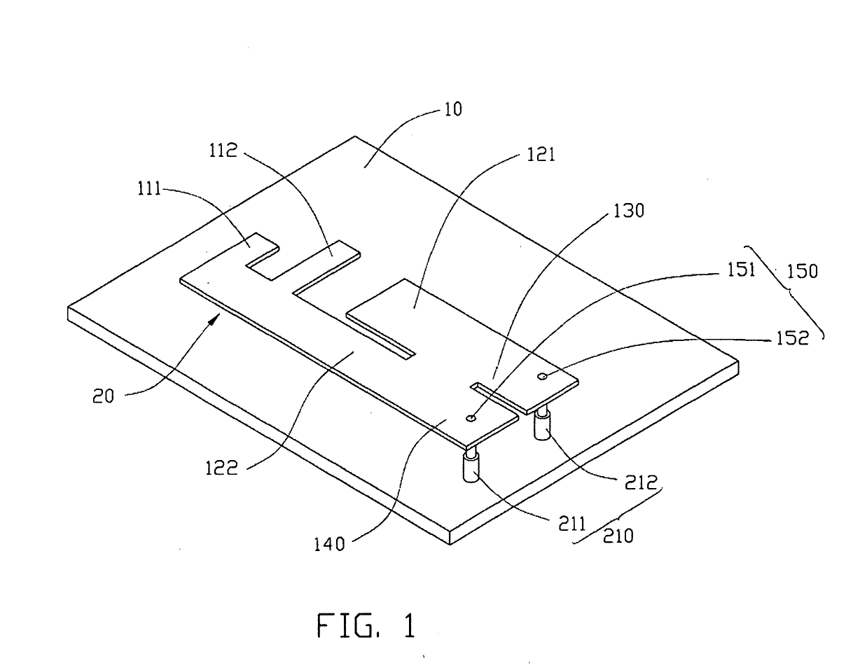

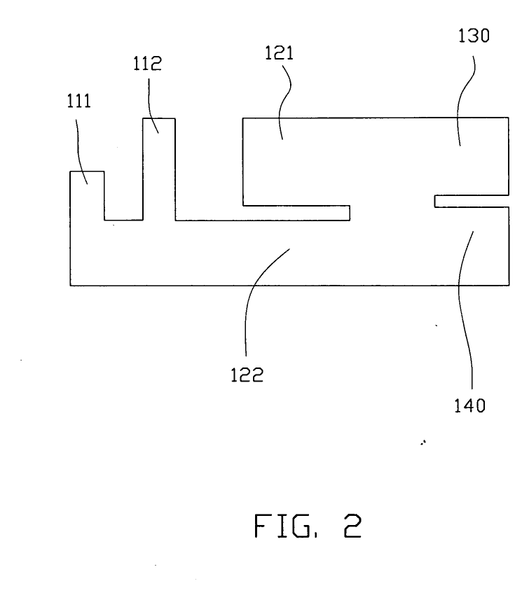

FIG. 1 is a schematic diagram of a multiband antenna 20 in accordance with the disclosure, and FIG. 2 is a top view of the multiband antenna 20 of FIG. 1. In this embodiment, the multiband antenna 20 is located on a substrate 10 and includes a feed portion 130, a grounding portion 140, and an antenna body. The feed portion 130 delivers electromagnetic signals. The antenna body is electrically connected to the feed portion 130 and the grounding portion 140, and receives and transmits electromagnetic signals. The antenna body comprises a first resonator 111, a second resonator 112, a first radiator 121 and a second radiator 122.

The described multiband antenna 20 is connected to probes 210 of variable length via probe points 150, and connected to the substrate 10 via the probes 210. The probes 210 with variable lengths comprise a first probe (grounding portion) 211 and a second probe (feed probe) 212. The probe points 150 include a first probe point 151 and a second probe point 152. The first probe 211 is connected between the first probe point 151 of the ground portion 140 and the substrate 10, and the second probe 212 is connected between the second probe point 152 of the feed portion 130 and the substrate 10. The first probe 211 is parallel to the second probe 212, and perpendicularly connected between the multiband antenna 20 and substrate 10.

The first resonator 111, the second resonator 112, and the second radiator 122 collectively form an “F” shape. First resonator 111 is shorter than second resonator 112, both of which generate coupling effects on each other. The multiband antenna 20 may be operated in different frequency bands by changing lengths or relative positions of the first resonator 111 and the second resonator 112.

The feed portion 130 is electrically connected to the first radiator 121, delivering electromagnetic signals thereto. The first radiator 121 and the second radiator 122 define a rectangular groove between the first radiator 121 and the second radiator 122. First radiator 121, near the feed probe 212 is narrower than a part far away from the feed probe 212. The second radiator 122 near the grounding probe 211 is wider than a part away from the grounding probe 211. The second resonator 112, the first radiator 121, and the second radiator 122 collectively form an inverted “L” shaped groove. The feed portion 130 and the ground portion 140 define a rectangular groove therebetween, which prevents frequency offset therebetween. The second resonator 122 is electrically connected to the ground portion 140.

The multi-antenna 20 functions at frequencies of 2.4 GHz and 5.X GHz etc.

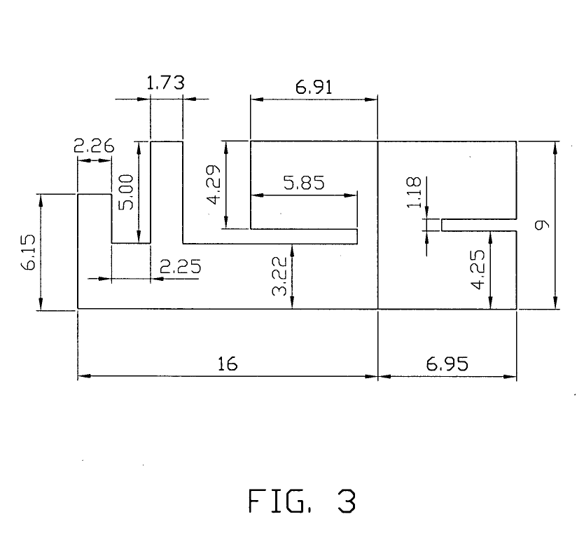

FIG. 3 shows dimensions of the multiband antenna 20 of FIG. 1. Area of the antenna body is about 16 mm×9 mm, length of the first radiator 121 is about 6.91 mm, and width of the first radiator 121 is about 4.29 mm. Length of the second radiator 122 is about 16 mm, and width is about 3.22 mm. Width of the first resonator 111 is about (6.15 mm−3.22 mm) 2.93 mm. Length of the second resonator 112 is about 5.00 mm, and width is about 1.73 mm. The first resonator 111 is parallel to the second resonator 112, and a distance therebetween is about 2.25 mm. The lengths and widths of the first resonator 111 and the second resonator 112 can be adjusted for compatibility with other frequencies. The ground portion 140 is parallel to the feed portion 130, with length of each about 6.95 mm. The width of the grounding portion 140 is about 4.24 mm. A rectangular groove defined between the grounding portion 140 and the feed portion 130 has a width of about 1.18 mm, and accordingly a width of the feed portion is about 9 mm−4.24 mm−1.18 mm=3.58 mm. The first probe 211 and the second probe 212 both have lengths of 5 mm.

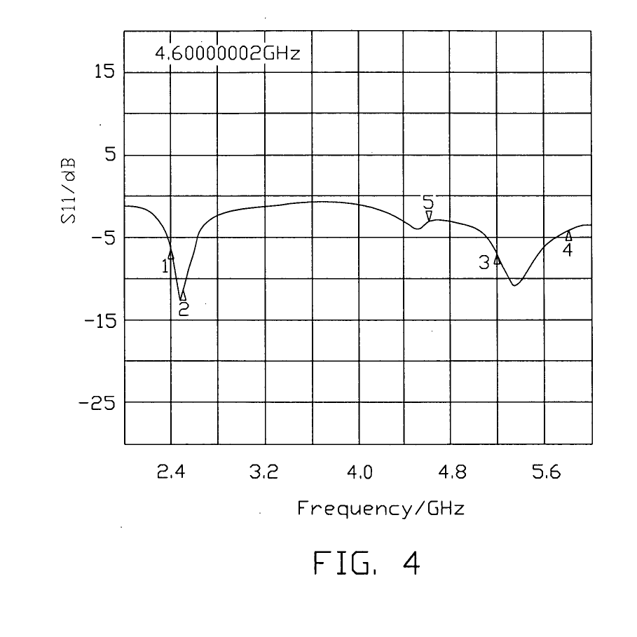

FIG. 4 is a graph showing a return loss of the multiband antenna 20 of FIG. 1. At point 1, the frequency is 2.4 GHz, and the return loss is about −6.48 dB. At point 2, the frequency is 2.5 GHz, and the return loss is about −11.62 dB. At point 3, the frequency is 5.2 GHz, and the return loss is about −7.00 dB. At point 4, the frequency is 5.8 GHz, and the return loss is about −4.20 dB. As shown, the multiband antenna 20 complies with industry standards.

The description of the disclosure has been presented for purposes of illustration and description, and is not intended to be exhaustive or limited to the disclosure in the form disclosed. Many modifications and variations will be apparent to those of ordinary skill in the art. The embodiment was chosen and described in order to best explain the principles of the disclosure, the practical application, and to enable others of ordinary skill in the art to understand the disclosure for various embodiments with various modifications as are suited to the particular use contemplated.

What is claimed is:

1. A multiband antenna located on a substrate, comprising:
a plurality of probes of varying length;
a feed portion connected to the substrate via a first probe and configured for delivering electromagnetic signals;
a grounding portion connected to the substrate via a second probe; and
an antenna body connected to the feed portion and the grounding portion and configured for transceiving electromagnetic signals, the antenna body comprising:
a first radiator connected to the feed portion;
a second radiator connected to both the first radiator and the grounding portion;
a first resonator connected to the second radiator; and
a second resonator connected to the second radiator;
wherein the first resonator and the second resonator are parallel and of different lengths.

2. The multiband antenna as claimed in claim 1, wherein the second radiator, the first resonator, and the second resonator collectively form an “F” shape.

3. The multiband antenna as claimed in claim 2, wherein the first radiator is shorter than the second radiator.

4. The multiband antenna as claimed in claim 3, wherein the first radiator and the second radiator define a rectangular groove therebetween.

5. The multiband antenna as claimed in claim 4, wherein the second resonator, the first radiator, and the second radiator collectively form an inverted “L” shaped groove.

6. The multiband antenna as claimed in claim 1, wherein a length of the feed portion is equal to that of the grounding portion.

7. The multiband antenna as claimed in claim 6, wherein the feed portion and the grounding portion define a rectangular groove therebetween.

8. The multiband antenna as claimed in claim 1, wherein the probes are parallel.

9. A multiband antenna located on a substrate, comprising:
a feed probe located on the substrate;
a grounding probe electrically connected to the substrate; and
an antenna body transceiving electromagnetic signals, comprising:
a first radiator electrically connected to the feed probe;
a second radiator parallel to the first radiator and electrically connected to both the first radiator and the grounding probe; and
at least two resonators of different lengths, perpendicularly connected to the second radiator toward to the first radiator.

10. The multiband antenna as claimed in claim 10, wherein a plane collectively formed by the first radiator and the second radiator is parallel to the substrate.

11. The multiband antenna as claimed in claim 10, wherein the first radiator near the feed probe is narrower than part away from the feed probe.

12. The multiband antenna as claimed in claim 12, wherein the second radiator near the grounding probe is wider than part away from the grounding probe.

13. The multiband antenna as claimed in claim 10, wherein the feed probe and the grounding probe are both variable in length.
